(19) United States
(12) Patent Application Publication
(10) Pub. No.: US 2005/0069255 A1
(43) Pub. Date: Mar. 31, 2005

(54) Optical module, optical fiber laser device and image display device

(75) Inventors: Nobuyuki Nishimura, Fukaya-shi (JP); Tooru Sugiyama, Kumagaya-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/947,400

(22) Filed: Sep. 23, 2004

(30) Foreign Application Priority Data
Sep. 30, 2003 (JP) 2003-342327

(51) Int. Cl. G02B 6/26

(52) U.S. Cl. 385/31; 385/27

(57) ABSTRACT

The fast-axis and slow-axis direction components of light exited from any light emitting sections are respectively independently collimated to allow the light beams which are collimated in both the fast-axis and slow-axis directions to be shaped and/or image-converted to a predetermined cross-sectional configuration at least relative to the slow-axis direction components and allow the light beams which are given the predetermined cross-sectional configuration to be condensed to a predetermined position. By doing so it is possible to reduce any loss involved upon the optical coupling of a laser array to an optical fiber.

### CROSS-REFERENCE TO RELATED APPLICATIONS

This application is based upon and claims the benefit of priority from prior Japanese Patent Application No. 2003-342327, filed Sep. 30, 2003, the entire contents of which are incorporated herein by reference.

### BACKGROUND OF THE INVENTION

1. Field of the Invention

The present invention relates to an optical module for allowing light beams which exit from a laser array to be optically coupled to an optical fiber with high efficiency and high density, an optical fiber laser device using this optical module, and an image display device using this optical fiber device.

2. Description of the Related Art

A semiconductor laser array with a plurality of emitters (light emitting points) arranged therein has been variously utilized because it can produce a high-output laser beam.

However, since the semiconductor laser is not symmetrical in the widths of their emitters between a fast-axis perpendicular to an active layer and a slow-axis horizontal to the active layer and, further, the broadening of the laser beam is also not symmetrical, it is difficult to condense the beam into a very fine spot. In this connection it is to be noted that achieving this is particularly difficult in the semiconductor laser array due to the need to provide a plurality of emitters.

JPN. PAT. APPLN. KOKAI PUBLICATION NO. 11-17268 discloses an optical system comprising a lens array configured to collimate beams exiting from respective emitters to allow the condensing of beams emitted from a semiconductor laser array and a condensing lens configured to condense the laser beams.

However, the invention disclosed in the publication above comprises a mere combination of a lens array and light condensing lens in which the condensed beam shape becomes a stripe-like one because this state is directly reflected by the light emitting sections of the semiconductor laser array. Therefore, there arises a problem in which the resultant beam cannot be correctly optically coupled to an optical fiber of a very small core diameter.

### BRIEF SUMMARY OF THE INVENTION

According to an aspect of the present invention there is provided an optical module comprising:
a first optical element configured to collimate laser beams exited from corresponding light emitting sections in a laser array;
a second optical element configured to enable those collimated beams which are oriented along that active layer to be arrayed perpendicular to the active layer;
a third optical element configured to effect an image conversion in a direction along the active layer; and
a fourth optical element configured to condense the laser beams.

According to another aspect of the present invention there is provided an optical fiber laser device comprising:
a first optical element configured to collimate laser beams exited from a plurality of laser emitting sections in a laser array which are arranged in a direction along that active layer;
a second optical element configured to enable those collimated beams which are oriented along the active layer to be arrayed perpendicular to the active layer;
a third optical element configured to effect an image conversion in a direction along the active layer;
an optical fiber to which a laser active material having a predetermined characteristic is added;
an optical resonator including a first mirror and a second mirror at one end side and at the other side of the optical fiber and configured to amplify the laser beam which is produced in the optical fiber to a predetermined strength and enable that laser beam which exceeds the predetermined strength to be output to an outside; and
a fourth optical element configured to condense the laser beam from the third optical element and input a resultant laser beam to the optical fiber.

According to still another aspect of the present invention there is provided an image display device comprising:
a plurality of laser devices configured to output R beam, G beam and B beam;
condensing means configured to combine output beams from the corresponding laser devices and output a white beam;
a spatial modulation element configured to enable the white beam which is exited from the condensing means to be space-modulated based on image information corresponding to the image signal; and
an optical element configured to image an output image beam which is space-modulated by the space modulation element onto a predetermined position,
wherein at least one of the plurality of laser devices comprises a first optical element configured to collimate laser beams exited from a plurality of laser emitting sections in a laser array which are arranged along that active array, a second optical element configured to enable these collimated beams which are oriented along the active layer to be arrayed perpendicular to the active layer, a third optical element configured to effect an image conversion in a direction along the active layer, and a fourth optical element configured to condense the laser beams.

According to further another aspect of the present invention there is provided an image display device comprising:
a plurality of laser devices configured to output a R beam, G beam and B beam;
condensing means configured to combine these output beams from the corresponding laser devices and output a white beam;
a spatial modulation element configured to enable the white beam which is exited from the condensing means to be space-modulated based on image information corresponding to the image signal; and
an optical element configured to image an output image beam which is space-modulated by the space modulation element onto a predetermined position,
wherein at least one of the plurality of laser devices comprises a first optical element configured to collimate laser beams exited from a plurality of laser emitting sections in an array which are arranged along an active layer, a second optical element configured to enable those collimated beams which are oriented along the active layer to be arrayed perpendicular to the active layer, a third optical element configured to effect an image conversion in a direction along the active layer, an optical fiber to which a laser active material is added, first and second mirrors provided at one end side and at the other end side of the optical fiber and configured to amplify a beam which is produced in the optical fiber to a predetermined strength and output the beam which exceeds the predetermined strength onto an outside, and a fourth optical element configured to condense the laser beams from the third optical element and input a resultant beam to the optical fiber.

According to still further another aspect of the present invention there is provided a method for optically coupling a laser array having an active layer with a plurality of laser emitting sections arranged therealong to an optical fiber, comprising:
a step of collimating those fast-axis ones of first-axis and slow-axis direction components in light which are output from any light emitting sections;
a step of collimating the slow-axis direction components of the light through a collimating lens array to which the same pitch as an interval of the light emitting sections are applied;
a step of causing the light beams which are collimated in both the fast-axis and slow-axis directions to be shaped/image-converted by beam shaping means and image conversion means to a predetermined cross-sectional configuration relative to at least the slow-axis direction components; and
a step of guiding the light which are given a predetermined cross-sectional configuration by the image conversion onto an optical fiber through a condensing lens.

### BRIEF DESCRIPTION OF THE SEVERAL VIEWS OF THE DRAWING

FIGS. 1A and 1B each are a diagrammatic view showing one example of a laser device according to an embodiment of the present invention;

FIG. 2 is a diagrammatic view for explaining the state of exiting laser beams from a semiconductor laser array incorporated into an optical module as shown in FIGS. 1A and 1B;

FIGS. 3A to 3D, each, show a diagrammatic view for explaining the action of a beam shaping prism incorporated into the optical module as shown in FIGS. 1A and 1B;

FIG. 4 is a diagrammatic view for explaining another example of an optical module, as shown in FIGS. 1A and 1B, according to another embodiment of the present invention;

FIG. 5 is a diagrammatic view for explaining one example of an optical fiber laser device (an up-conversion laser device) using the optical module, as shown in FIGS. 1A and 1B, as a stimulating beam source; and

FIG. 6 is a diagrammatic view for explaining one example of an image display device using, as a light source, the optical module according to the embodiment of the present invention.

### DETAILED DESCRIPTION OF THE INVENTION

With reference to the drawing, an explanation will be made in more detail below about the embodiments of the present invention.

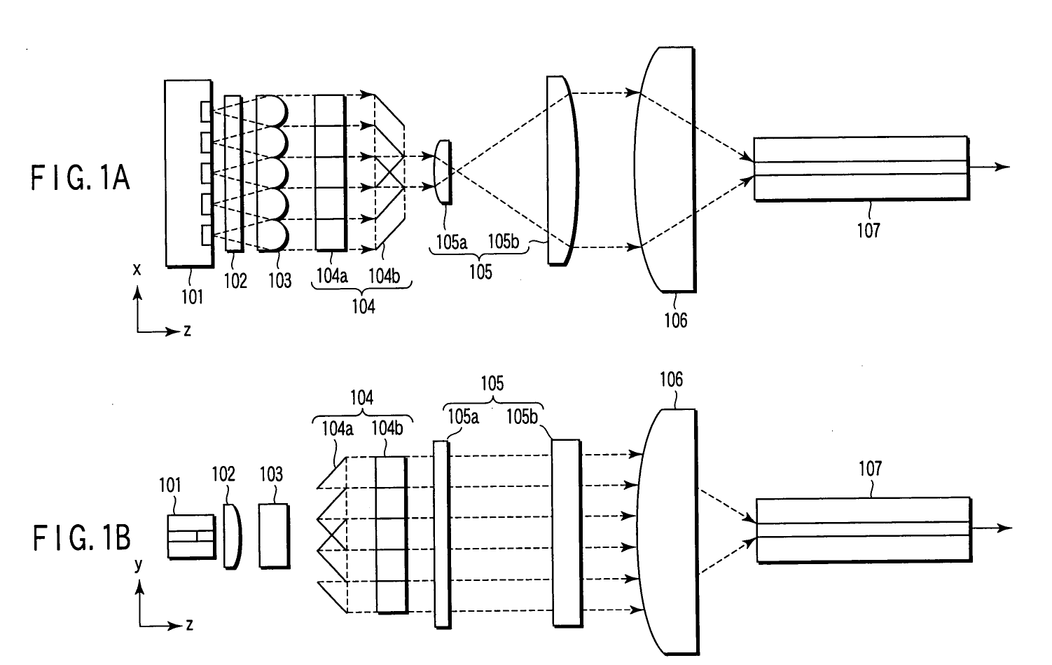

FIGS. 1A and 1B show one example of an optical module to which the embodiment of the present invention is applied, FIG. 1A being a y-z plan view and FIG. 1B an x-z plan view.

The optical module 100 of the present invention includes a monolithic semiconductor laser array 101 having an active layer with a plurality of light emitting points arranged therein, a collimating cylindrical lens 102 for collimating fast axis (that is, y-axis) components, a collimating cylindrical lens array 103 for collimating slow-axis (that is, x-axis) components, a beam shaping prism 104 (first and second beam shaping prisms 104a and 104b), a beam expander (first and second cylindrical lenses 105a and 105b) having a curvature in the slow-axis direction, a light condensing lens 106, and so on, whereby beams are optically coupled to an optical fiber 107 at a focal position (output end) of the light condensing lens 106 (the laser beam can be input to the optical fiber 107 at the focal position of the light condensing lens 106).

The semiconductor laser array 101 is such that, for example, a number, n, of (for example, five) 2 μm×150 μm emitters (light emitting points) are arranged at a pitch of 0.5 mm along the active layer not set out in detail.

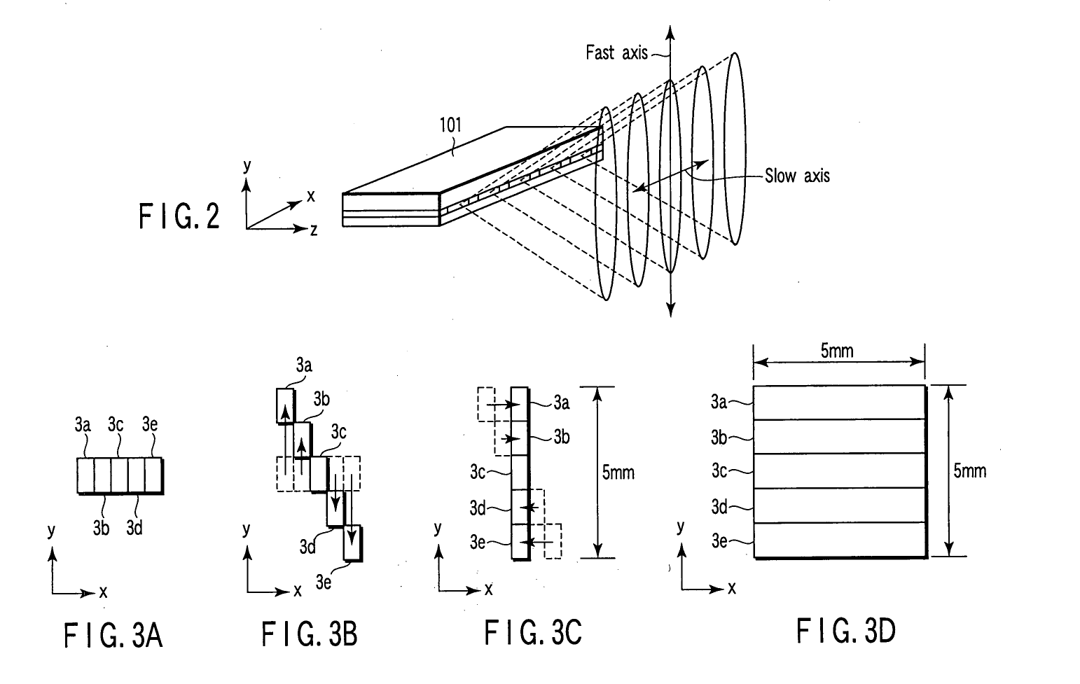

Laser beams are exited from the emitters at a broadening angle corresponding to a half angle of about 30° with respect to the y axis and half angle of about 5° with respect to the x axis as shown in FIG. 2.

The laser beams exited from the respective emitters of the semiconductor laser array 101 are collimated by the fast-axis collimating lens 102 with respect to the y-axis.

The laser beams collimated by the fast-axis collimating lens 102 have their emitter-exited laser beams collimated by the slow-axis collimating lens array 103 with respect to the x-axis. In this connection it is to be noted that, if the respective emitters of the semiconductor laser array 101 are arranged at a pitch of 0.5 mm, then the slow-axis collimating lens array is also formed at a 0.5 mm pitch array so as to secure collimation with no overlap occurring between the laser beams exited from the emitters.

The beams exited from the slow-axis collimating lens array 103 (passed through the array 103) are oriented along the active layer as shown in FIG. 3A. If, at this time, for example, the focal distance of the fast-axis collimating lens 102 is about 1 mm and the focal distance of each lens of the slow-axis collimating lens array 103 is about 2 mm, then the beam exited from the respective emitter is formed to have a rectangular shape of 1 mm in the y-axis direction and 0.5 mm in the x-axis direction and, if five emitters are used, a laser beam of a cross-sectional shape of 1 mm×2.5 mm is obtained.

The intervals of the laser beams (FIG. 3A) collimated by the collimating lens 102 and collimating lens array 103 are expanded by the beam shaping prism 104 in the x direction as shown in FIG. 3B and expanded in the y direction as shown in FIG. 3C and, finally, the beams are shaped (image-converted) as shown in FIG. 3D. In this case, the laser beams having a width of 1 mm×2.5 mm are shaped to a 10 mm×0.5 mm laser beam.

The laser beam of a certain cross-sectional shape is condensed by the condensing lens 106 and input to the optical fiber (optically coupled to the fiber 107).

In order to allow the laser beams which are condensed by the condensing lens 106 to be input (optically coupled) with higher efficiency to the optical fiber 107 of a very small core diameter, the cross-sectional shapes of the beams are further changed preferably by the beam expander 105 (first and second cylindrical lenses 105a and 105b). Since, for example, a laser beam spot size and shape formed by the beam shaping prism 104 are so defined as to coincide with the core diameter-of the optical fiber 107, these are image-converted by the beam expander 105 with respect to the slow-axis.

Stated in more detail, the laser beams having a width of 10 mm×0.5 mm explained in connection with FIG. 3D are converted to a laser beam having a width of 10 mm×10 mm with the use of two cylindrical lenses having a focal distance of, for example, about 1:20 and a predetermined curvature with respect to the slow-axis only.

If the laser beam is condensed by the condensing lens 106 having a focal distance of about 10 mm, the spot size becomes about 20 μm×40 μm and it can be correctly optically coupled to the optical fiber 107 of a very small core diameter.

In this way, the optical module of the present invention can be optically coupled with higher coupling efficiency to the optical fiber by means of the condensing lens by, upon optically coupling the laser array having an active layer with a plurality of laser emitting sections arranged therein to the optical fiber, allowing the beams which exit from the light emitting sections to be collimated with the use of both the fast-axis collimating lens and the slow-axis collimating lens array having the same pitch as the interval of the respective light emitting sections and allowing the collimated beams which are arrayed along the active layer to be shaped in a direction perpendicular to the active layer, and, in order to allow the spot size which is defined upon the condensing of the beams by the condensing lens to be aligned with the core size of the optical fiber, allowing the beam which has been shaped and collimated in a direction perpendicular to the active layer to be image-converted (expanded in the slow-axis direction) by the beam expander.

By constructing the optical system as set out above, it is possible to correctly optically couple the semiconductor laser array to the optical fiber of a very small core diameter (the laser beams output from the semiconductor laser can be efficiently input to the optical fiber. It is needless to say that, by an interchange of the collimate lens with the collimating lens array, the slow-axis direction components can be collimated in advance of collimating the fast-axis direction component.

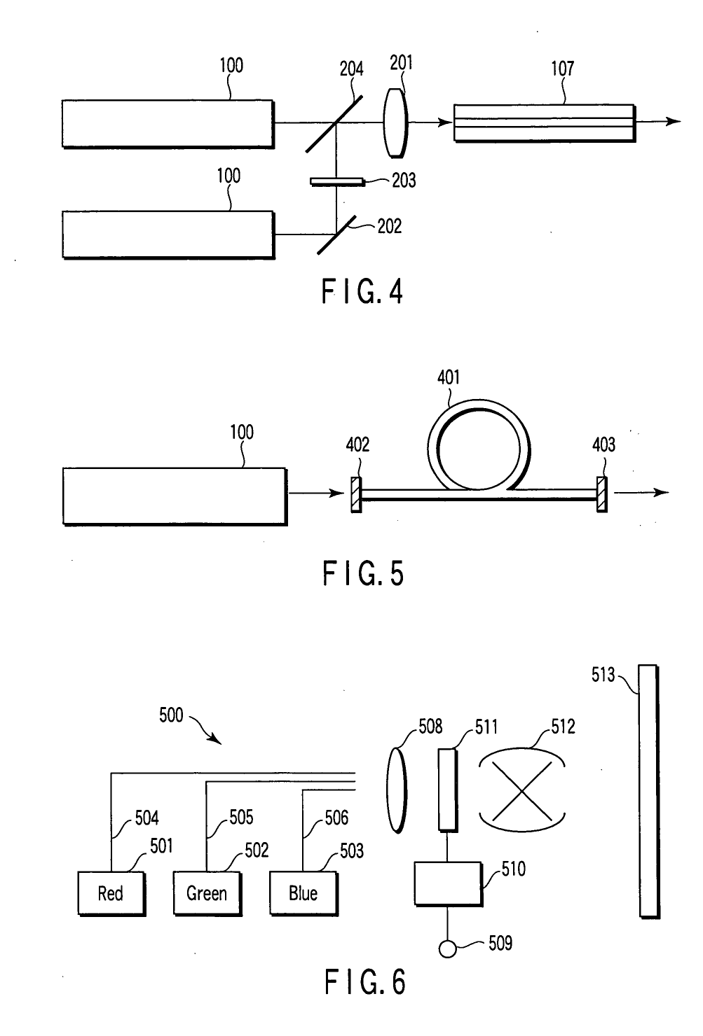

As shown in FIG. 4, two sets of optical modules 100 explained in connection with FIGS. 1A and 1B are prepared. In this case, their respective laser beams are combined by a combining mirror (polarizing beam splitter) 204 and the combined beam is input by a condensing lens 201 to an optical fiber 107 (is optically coupled by the condensing lens 201 to the optical fiber 107), so that the strength of the laser beam input to the optical fiber 107 can be generally doubled, in which case a corresponding loss is disregarded.

In this case, the optical module 100 is comprised of a semiconductor laser and the polarization direction of an output laser beam is such that the direction parallel to a plane direction of an active layer becomes an “S Polarization”. It is needless to say that the polarization direction of the laser beam which is reflected by a mirror 202 and directed to the combining mirror 204 is changed by a λ/2 plate (phase plate) to a direction reflected by the combining mirror 204.

Further, it is possible to enhance the light intensity by further adding such combining mirror and optical module and combining laser beams from three or more optical modules.

FIG. 5 is a diagrammatic view showing one example of an optical fiber laser device (up-conversion laser) using, as a stimulating light source, the optical module as set out above in connection with FIGS. 1A and 1B.

In FIG. 5, the optical fiber 401 is of such a type that, to its core, a laser active material such as Pr³⁺/Yb³⁺ and Tm³⁺ is added.

Across the optical fiber 401 an input-side mirror (first reflection element) 402 and an output-side mirror (second reflection element) 403 are provided, the input-side mirror being configured to allow the stimulated beam which exits from an stimulating light source 100, that is, a semiconductor laser array 101 explained in connection with FIGS. 1A and 1B to be transmitted and input to the optical fiber 401 and allow a laser beam which is produced in the optical fiber 401 to be reflected and the output-side mirror being configured to allow the laser beam which is produced in the optical fiber 401 to be partially reflected and deliver a laser beam output at a time when the strength of this laser beam is above a predetermined strength.

If, for example, the wavelength of the stimulated light from the semiconductor laser array 101 (stimulated light source 100) is 830 to 850 nm, the laser active material in the core of the optical fiber 401 is Pr³⁺/Yb³⁺ and the characteristic of the input-side mirror 401 has a total reflection of 635 nm at a full transmission of 830 to 850 nm and the characteristic of the output-side mirror 403 has a partial reflection of 635 nm, then the stimulated light incident on the optical fiber 401 is absorbed in the Pr³⁺/Yb³⁺ and light of 635 nm is produced.

The produced light of 635 nm is amplified to a predetermined strength in a resonator comprising the input-side mirror 402, the output-side mirror 403 and the optical fiber 401 and resultant light is output from the output-side mirror 403. Where a laser beam is obtained by such an up-conversion, it is necessary to prepare high-output and high-density stimulated light, and it is particularly effective to utilize the optical module as set out in connection with FIGS. 1A and 1B. As explained above in connection with FIG. 4, it is needless to say that, by using a combined laser beam from two or more optical modules it is possible to obtain still higher output stimulated light.

FIG. 6 is a diagrammatic view for explaining one example of an image display device using, as a light source, the optical module as shown in FIGS. 1A and 1B (or FIG. 5).

As shown in FIG. 6, an image display device 500 has first, second and third light sources 501 (R beam), 502 (G beam) and 503 (B beam) configured to display a color image by a additive-mixing-of-colors method. It is to be noted that, as at least one of these light sources, for example, the light source 503 (B beam), use is made of the laser device set out above in connection with FIGS. 1A and 1B (or FIG. 5). It is also needless to say that, as at least one of these light sources use may be made of a high-output optical module set out above in connection with FIG. 4.

The R beam, G beam and B beam which are output from the corresponding light sources 501, 502 and 503 are guided by their connected optical fibers 504, 505 and 506 onto a lens 508 to, while changing these beams to parallel beams, combine them. As a result, the beams which pass through the lens 508 become a white beam.

The white beam which is output from the lens 508 is space-modulated (imaged), by a liquid crystal panel 511, based on an image signal input to an image input terminal 509 and projected onto a screen 513 through a projection lens 512. In this case, the liquid crystal panel 511 is operated by a liquid crystal driving means 510.

Since, as the light sources for the projection type image display device shown in FIG. 6, the red(R), green(G), and blue(B) beams of a few W to a few tens of W are required, the output may be insufficient. By using the optical module or the fiber laser device of the present invention, however, it is possible to realize a high-output, compact image display device.

In the image display device shown in FIG. 6, when the red(R), green(G) and blue(B) beams are made parallel by the lens 508, these color beams are combined into a white beam and the resultant beam is projected onto the liquid crystal panel 511. It is needless to say that an independent liquid crystal panel is provided for each of the red(R), green(G) and blue(B) beams and, even for the light sources for the image display device which allow the superimposition of three color components as an image, it is also possible to utilize the optical module or optical fiber laser device.

The present invention is not restricted to the above-mentioned embodiments as they are and their constituent elements can be variously modified/embodied without departing from the essence of the present invention. Various embodiments of the present invention can be achieved by properly combining a plurality of constituent elements disclosed in the embodiments. For example, some constituent elements may be eliminated from all the constituent elements of the embodiments of the present invention.

According to the present invention, it is possible to enhance the quality of a laser beam obtained from the semiconductor laser array and thus to achieve a high-output stable laser beam. Further, since it is possible to enhance the efficiency with which optical coupling is made to the optical fiber, it is possible to make a resultant optical module compact by which it is still possible to obtain a laser beam whose output is the same as that of the conventional device. Further, the size of a resultant image device can be reduced by incorporating the present invention into the image display device.

1. An optical module comprising:
a first optical element configured to collimate laser beams exited from corresponding light emitting sections in a laser array;
a second optical element configured to enable those collimated beams which are oriented along that active layer to be arrayed perpendicular to the active layer;
a third optical element configured to effect an image conversion in a direction along the active layer; and
a fourth optical element configured to condense the laser beams.

2. An optical module according to claim 1, wherein the third optical element has a predetermined magnification relative to a slow-axis direction component of the laser beam exited from that laser array.

3. An optical module according to claim 1, wherein the second optical element includes beam shaping means configured to shape a cross-sectional configuration of the laser beam to a predetermined configuration relative to fast-axis and slow-axis direction components exited from the laser array.

4. An optical module according to claim 1, further comprising
synthesizing means configured to enable laser beams from a light emitting unit to be combined at a preceding stage of the fourth optical element, said light emitting unit comprising the first to third optical elements and laser array.

5. An optical fiber laser device comprising:
a first optical element configured to collimate laser beams exited from a plurality of laser emitting sections in a laser array which are arranged in a direction along that active layer;
a second optical element configured to enable those collimated beams which are oriented along the active layer to be arrayed perpendicular to the active layer;
a third optical element configured to effect an image conversion in a direction along the active layer;
an optical fiber to which a laser active material having a predetermined characteristic is added;
an optical resonator including a first mirror and a second mirror at one end side and at the other side of the optical fiber and configured to amplify the laser beam which is produced in the optical fiber to a predetermined strength and enable that laser beam which exceeds the predetermined strength to be output to an outside; and
a fourth optical element configured to condense the laser beam from the third optical element and input a resultant laser beam to the optical fiber.

6. An optical fiber laser device according to claim 5, wherein the third optical element has a predetermined amplification relative to a slow-axis direction component of the laser beam exited from the laser array.

7. An optical fiber laser device according to claim 5, wherein the second optical element includes beam shaping means configured to shape a cross-sectional configuration of the laser beam to a predetermined configuration relative to fast-axis and slow-axis direction components exited from the laser array.

8. An image display device comprising:
a plurality of laser devices configured to output R beam, G beam and B beam;
condensing means configured to combine output beams from the corresponding laser devices and output a white beam;
a spatial modulation element configured to enable the white beam which is exited from the condensing means to be space-modulated based on image information corresponding to the image signal; and
an optical element configured to image an output image beam which is space-modulated by the space modulation element onto a predetermined position,
wherein at least one of said plurality of laser devices comprises a first optical element configured to collimate laser beams exited from a plurality of laser emitting sections in a laser array which are arranged along that active array, a second optical element configured to enable these collimated beams which are oriented along the active layer to be arrayed perpendicular to the active layer, a third optical element configured to effect an image conversion in a direction along the active layer, and a fourth optical element configured to condense the laser beams.

9. An image display device comprising:
a plurality of laser devices configured to output a R beam, G beam and B beam;
condensing means configured to combine these output beams from the corresponding laser devices and output a white beam;
a spatial modulation element configured to enable the white beam which is exited from the condensing means to be space-modulated based on image information corresponding to the image signal; and
an optical element configured to image an output image beam which is space-modulated by the space modulation element onto a predetermined position,
wherein at least one of said plurality of laser devices comprises a first optical element configured to collimate laser beams exited from a plurality of laser emitting sections in an array which are arranged along an active layer, a second optical element configured to enable those collimated beams which are oriented along the active layer to be arrayed perpendicular to the active layer, a third optical element configured to effect an image conversion in a direction along the active layer, an optical fiber to which a laser active material is added, first and second mirrors provided at one end side and at the other end side of the optical fiber and configured to amplify a beam which is produced in the optical fiber to a predetermined strength and output the beam which exceeds the predetermined strength onto an outside, and a fourth optical element configured to condense the laser beams from the third optical element and input a resultant beam to the optical fiber.

10. A method for optically coupling a laser array having an active layer with a plurality of laser emitting sections arranged therealong to an optical fiber, comprising:
a step of collimating those fast-axis ones of first-axis and slow-axis direction components in light which are output from any light emitting sections;
a step of collimating the slow-axis direction components of the light through a collimating lens array to which the same pitch as an interval of the light emitting sections are applied;
a step of causing the light beams which are collimated in both the fast-axis and slow-axis directions to be shaped/image-converted by beam shaping means and image conversion means to a predetermined cross-sectional configuration relative to at least the slow-axis direction components; and
a step of guiding the light which are given a predetermined cross-sectional configuration by the image conversion onto an optical fiber through a condensing lens.

11. A method according to claim 10, wherein light beams from two or more laser arrays are combined at a preceding stage of the optical fiber.

12. A method according to claim 10, wherein the slow-axis direction components are collimated in advance of the collimation of the first-axis direction components.
